(19) United States
(12) Patent Application Publication
(10) Pub. No.: US 2022/0011221 A1
(43) Pub. Date: Jan. 13, 2022

(54) OPTICAL RESONATOR, CARBON ISOTOPE ANALYSIS DEVICE USING SAME, AND CARBON ISOTOPE ANALYSIS METHOD

(71) Applicants: SEKISUI MEDICAL CO., LTD., Tokyo (JP); NATIONAL UNIVERSITY CORPORATION TOKAI NATIONAL HIGHER EDUCATION AND RESEARCH SYSTEM, Aichi (JP)

(72) Inventors: Kenji YOSHIDA, Tokyo (JP); Shin-ichi NINOMIYA, Tokyo (JP); Hideki TOMITA, Aichi (JP); Tetsuo IGUCHI, Aichi (JP); Norihiko NISHIZAWA, Aichi (JP); Volker SONNENSCHEIN, Aichi (JP); Ryohei TERABAYASHI, Aichi (JP)

(73) Assignees: SEKISUI MEDICAL CO., LTD., Tokyo (JP); NATIONAL UNIVERSITY CORPORATION TOKAI NATIONAL HIGHER EDUCATION AND RESEARCH SYSTEM, Aichi (JP)

(21) Appl. No.: 17/293,668

(22) PCT Filed: Nov. 21, 2019
(86) PCT No.: PCT/JP2019/045682

§ 371 Date: May 13, 2021

(30) Foreign Application Priority Data
Nov. 21, 2018 (JP) 2018-217929
Nov. 21, 2018 (JP) 2018-217938

(51) Int. Cl. G01N 21/3504; G01N 21/39

(52) U.S. Cl. CPC G01N 21/3504; G01N 2201/08; G01N 2201/06113; G01N 21/39

(57) ABSTRACT

A carbon isotope analysis method, including the steps of: generating carbon dioxide isotope from carbon isotope; feeding the carbon dioxide isotope into an optical resonator having a pair of mirrors; applying irradiation light having an absorption wavelength of the carbon dioxide isotope into the optical resonator; adjusting a relative positional relationship between the mirrors so that an optical axis of the irradiation light and an optical axis of light generated by the etalon effect are not matched; measuring the intensity of the transmitted light generated by resonance of carbon dioxide isotope excited by the irradiation light; and calculating the concentration of the carbon isotope from the intensity of the transmitted light. An optical resonator that can be suppressed in the parasitic etalon effect, and a carbon isotope analysis device and a carbon isotope analysis method, by use of the optical resonator, are provided.

### TECHNICAL FIELD

The present invention relates to an optical resonator that can be suppressed in the parasitic etalon effect, and a carbon isotope analysis device and a carbon isotope analysis method, by use of the optical resonator. In particular, the present invention relates to an optical resonator useful for analysis of radioactive carbon isotope ¹⁴C and the like, and a radioactive carbon isotope analysis device and a radioactive carbon isotope analysis method, by use of the optical resonator.

### BACKGROUND ART

Carbon isotope analysis has been applied to a variety of fields, including assessment of environmental dynamics based on the carbon cycle, and historical and empirical research through radiocarbon dating. The natural abundances of carbon isotopes, which may vary with regional or environmental factors, are as follows: 98.89% for ¹²C (stable isotope), 1.11% for ¹³C (stable isotope), and 1×10⁻¹⁰% for ¹⁴C (radioisotope). These isotopes, which have different masses, exhibit the same chemical behavior. Thus, artificial enrichment of an isotope of low abundance and accurate analysis of the isotope can be applied to observation of a variety of reactions.

In the clinical field, in vivo administration and analysis of a compound labeled with, for example, radioactive carbon isotope ¹⁴C are very useful for assessment of drug disposition. For example, such a labeled compound is used for practical analysis in Phase I or Phase IIa of the drug development process. Administration of a compound labeled with radioactive carbon isotope ¹⁴C (hereinafter may be referred to simply as “¹⁴C”) to a human body at a very small dose (hereinafter may be referred to as “microdose”) (i.e., less than the pharmacologically active dose of the compound) and analysis of the labeled compound are expected to significantly reduce the lead time for a drug discovery process because the analysis provides findings on drug efficacy and toxicity caused by drug disposition.

Examples of the traditional ¹⁴C analysis include liquid scintillation counting (hereinafter may be referred to as “LSC”) and accelerator mass spectrometry (hereinafter may be referred to as “AMS”).

LSC involves the use of a relatively small table-top analyzer and thus enables convenient and rapid analysis. Unfortunately, LSC cannot be used in clinical trials because of its low ¹⁴C detection sensitivity (10 dpm/mL). In contrast, AMS can be used in clinical trials because of its high ¹⁴C detection sensitivity (0.001 dpm/mL), which is less than one thousandth of that of LSC. Unfortunately, the use of AMS is restricted because AMS requires a large and expensive analyzer. For example, since only around fifteens of AMS analyzers are provided in Japan, analysis of one sample requires about one week due to a long waiting time for samples to be analyzed. Thus, a demand has arisen for development of a convenient and rapid method of analyzing ¹⁴C.

Some techniques have been proposed for solving the above problems (see for example, Non-Patent Document 1 and Patent Document 1.).

I. Galli, et al. reported the analysis of ¹⁴C of a natural isotope abundance level by cavity ring-down spectroscopy (hereinafter may be referred to as “CRDS”) in Non-Patent Document 1, and this analysis has received attention.

Unfortunately, the ¹⁴C analysis by CRDS involves the use of a 4.5-μm laser source having a very intricate structure, thus, a demand has arisen for a simple and convenient apparatus or method for analyzing ¹⁴C. Thus, the present inventors have uniquely developed an optical comb light source that generates an optical comb from a single light source and thus have completed a compact and convenient carbon isotope analysis device (see Patent Document 2).

### RELATED ART

### Patent Documents

Patent Document 1: Japanese Patent No. 3390755
Patent Document 2: Japanese Patent No. 6004412

### Non-Patent Document

Non-Patent Document 1: I. Galli et al., Phy. Rev. Lett. 2011, 107, 270802

### SUMMARY OF INVENTION

### Technical Problem

The present inventors have made further studies in order to achieve a further enhancement in analytical accuracy of a carbon isotope analysis device, and thus have found that CRDS causes reflection between surfaces of an optical resonator and an optical component on an optical path, and causes a high noise on a baseline, due to the occurrence of the parasitic etalon effect. Thus, a demand has arisen for an optical resonator that can be suppressed in the parasitic etalon effect.

An object of the present invention is to provide an optical resonator that can be suppressed in the parasitic etalon effect, and a carbon isotope analysis device and a carbon isotope analysis method, by use of the optical resonator.

### Solution to Problem

The present invention relates to the following aspect:

[1] A spectrometer including an optical resonator including a pair of mirrors, a photodetector that determines intensity of light transmitted from the optical resonator, and a first interference cancellation unit that adjusts a relative positional relationship between the mirrors.
[2] The spectrometer according to [1], wherein the first interference cancellation unit is an alignment mechanism which prevents interference of light on an optical axis of irradiation light applied into the optical resonator, on which one of the mirrors is mountable, and which is capable of three-dimensional position adjustment of the mirrors.
[3] The spectrometer according to [2], wherein the alignment mechanism satisfies at least one of:

(i) movability in respective directions of an X-axis, a Y-axis, and a Z-axis; and

(ii) rotatability in about 360 degrees around respective axes of the X-axis, the Y-axis, and the Z-axis;

in the case where the optical axis of irradiation light applied into the optical resonator is defined as the X-axis.
[4] The spectrometer according to any one of [1] to [3], wherein the spectrometer further includes a second interference cancellation unit.
[5] A carbon isotope analysis device including a carbon dioxide isotope generator provided with a combustion unit that generates gas containing carbon dioxide isotope from carbon isotope, and a carbon dioxide isotope purifying unit; the spectrometer according to any one of [1] to [4]; and a light generator.
[6] The carbon isotope analysis device according to [5], wherein the light generator includes a single light source, a first optical fiber that transmits first light from the light source, a second optical fiber that generates second light of a longer wavelength than the first light, the second optical fiber splitting from a splitting node of the first optical fiber and coupling with the first optical fiber at a coupling node downstream, a first amplifier that is disposed between the splitting node and the coupling node of the first optical fiber, a second amplifier that is disposed between the splitting node and the coupling node of the second optical fiber and that is different in band from the first amplifier, and a nonlinear optical crystal that allows a plurality of light beams different in frequency to propagate through to thereby generate a mid-infrared optical frequency comb of a wavelength range from 4.5 μm to 4.8 μm, from the difference in frequency, as light at an absorption wavelength of the carbon dioxide isotope.
[7] The carbon isotope analysis device according to [5] to [6], wherein the light generator further includes a delay line including a wavelength filter that separates the light from the light source to a plurality of spectral components, and a wavelength filter that adjusts the relative time delays of the plurality of spectral components and focuses the spectral components on the nonlinear crystal.
[8] A carbon isotope analysis method, including the steps of: generating carbon dioxide isotope from carbon isotope; feeding the carbon dioxide isotope into an optical resonator having a pair of mirrors; applying irradiation light having an absorption wavelength of the carbon dioxide isotope into the optical resonator; adjusting a relative positional relationship between the mirrors so that an optical axis of the irradiation light and an optical axis of light generated by the etalon effect are not matched; measuring the intensity of the transmitted light generated by resonance of carbon dioxide isotope excited by the irradiation light; and calculating the concentration of the carbon isotope from the intensity of the transmitted light.
[9] The carbon isotope analysis method according to [8], wherein the irradiation light is applied to radioactive carbon dioxide isotope ¹⁴CO₂.
[10] The carbon isotope analysis method according to [8] or [9], further including the steps of: measuring a first spectrum in the state where the optical resonator is not filled with gas; measuring a second spectrum in the state where the optical resonator is filled with a sample gas; and comparing the first and second spectra and removing an oscillation value.
[11] The carbon isotope analysis method according to any one of [8] to [10], including allowing a plurality of light beams to propagate through a nonlinear optical crystal to thereby generate a mid-infrared optical frequency comb of a wavelength range from 4.5 μm to 4.8 μm, as the irradiation light, due to the difference in frequency.

### Advantageous Effects of Invention

The present invention provides a resonator that can be suppressed in the parasitic etalon effect and thus can be decreased in noise on a baseline, and a carbon isotope analysis device and a carbon isotope analysis method, by use of the resonator.

### BRIEF DESCRIPTION OF DRAWINGS

FIG. 1 is a conceptual view of a first embodiment of a carbon isotope analysis device.

FIG. 2 is an assembly diagram of an alignment mechanism.

FIGS. 3A, 3B, and 3C illustrate movement of an alignment mechanism.

FIGS. 4A and 4B illustrate the principle of a method for removing the etalon effect by use of an alignment mechanism.

FIG. 5A illustrates a long-period oscillation observed in measurement with a conventional resonator, and FIG. 5B illustrates the ability of suppression of a long-period oscillation due to measurement with the resonator of the present invention.

FIGS. 6A and 6B illustrate the principle of high-rate scanning cavity ring-down absorption spectroscopy using a laser beam.

FIG. 7 illustrates the temperature dependence of CRDS absorption A of ¹³CO₂ and ¹⁴CO₂.

FIG. 8 is a conceptual view of a Modification of the optical resonator.

FIG. 9 illustrates absorption spectra in the 4.5-μm wavelength range of ¹⁴CO₂ and contaminant gases.

FIG. 10 is a conceptual view of a second embodiment of a carbon isotope analysis device.

FIG. 11 illustrates the relation between the absorption wavelength and the absorption intensity of an analytical sample.

FIG. 12 illustrates the principle of mid-infrared comb generation by use of one optical fiber.

FIG. 13A illustrates respective spectra of a case of a gas cell filled with a sample gas (CO₂) and a case of a gas cell not filled therewith. FIG. 13B illustrates a spectrum (before a subtraction treatment) measured in a case of a gas cell filled with a sample gas (CO₂) and a spectrum after the subtraction treatment.

FIGS. 14A and 14B are each a conceptual view of the etalon effect.

FIG. 15A illustrates a measured spectrum of a gas containing ¹⁴CO₂, and FIG. 15B illustrates an oscillation component extracted by determining the residual from the measured spectrum and a spectrum determined by calculation.

### DESCRIPTION OF EMBODIMENTS

The present invention will now be described by way of embodiments, which should not be construed to limit the present invention. In the drawings, the same or similar reference signs are assigned to components having the same or similar functions without redundant description. It should be noted that the drawings are schematic and thus the actual dimensions of each component should be determined in view of the following description. It should be understood that the relative dimensions and ratios between the drawings may be different from each other.

Throughout the specification, the term “carbon isotope” includes stable isotopes ¹²C and ¹³C and radioactive isotopes ¹⁴C, unless otherwise specified. In the case that the elemental signature “C” is designated, the signature indicates a carbon isotope mixture in natural abundance.

Stable isotopic oxygen includes ¹⁶O, ¹⁷O and ¹⁸O and the elemental signature “0” indicates an isotopic oxygen mixture in natural abundance.

The term “carbon dioxide isotope” includes ¹²CO₂, ¹³CO₂ and ¹⁴CO₂, unless otherwise specified. The signature “CO₂” includes carbon dioxide molecules composed of carbon isotope and isotopic oxygen each in natural abundance.

Throughout the specification, the term “biological sample” includes blood, plasma, serum, urine, feces, bile, saliva, and other body fluid and secretion; intake gas, oral gas, skin gas, and other biological gas; various organs, such as lung, heart, liver, kidney, brain, and skin, and crushed products thereof. Examples of the origin of the biological sample include all living objects, such as animals, plants, and microorganisms; preferably, mammals, preferably human beings. Examples of mammals include, but should not be limited to, human beings, monkey, mouse, rat, guinea pig, rabbit, sheep, goat, horse, cattle, pig, dog, and cat.

The present inventors have made studies in order to solve the above problems and to decrease a noise by the parasitic etalon effect, and as a result, have found that an optical axis of the original light and an optical axis of etalon can be displaced in an optical resonator to thereby eliminate baseline drifting. The inventors have made further studies, and as a result, have completed a novel spectrometer and a carbon isotope analysis device including the spectrometer. Hereinafter, such a novel spectrometer will be described through the description of a carbon isotope analysis device.

### [First Aspect of Carbon Isotope Analysis Device]

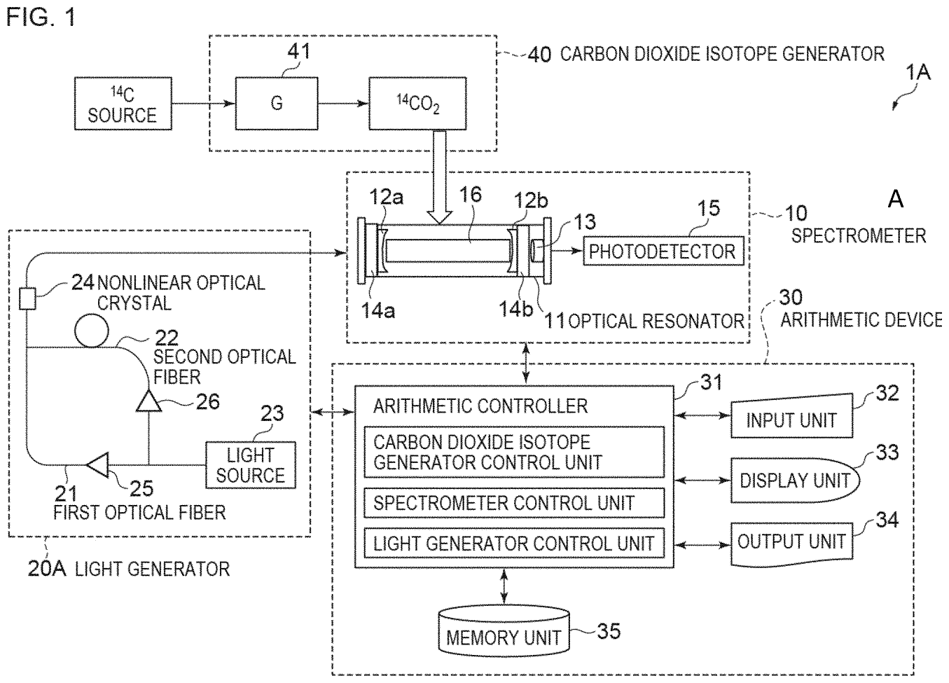

FIG. 1 is a conceptual view of a carbon isotope analysis device. The carbon isotope analysis device 1 includes a carbon dioxide isotope generator 40, a light generator 20, a spectrometer 10, and an arithmetic device 30.

In this embodiment, a radioisotope ¹⁴C, carbon isotope will be exemplified as an analytical sample. The light having an absorption wavelength range of the carbon dioxide isotope ¹⁴CO₂ generated from the radioisotope ¹⁴C is light of a 4.5-μm wavelength range. The combined selectivity of the absorption line of the target substance, the light generator, and the optical resonator mode can achieve high sensitivity (detail is described later).

### <Spectrometer>

With reference to FIG. 1, the spectrometer 10A includes an optical resonator 11 and a photodetector 15 that determines the intensity of the light transmitted from the optical resonator 11. The optical resonator or optical cavity 11 includes a cylindrical body to be filled with the target carbon dioxide isotope; a pair of highly reflective mirrors 12a and 12b respectively disposed at first and second longitudinal ends of the body such that the concave faces of the mirrors confront each other; a piezoelectric element 13 disposed at the second end of the body to adjust the distance between the mirrors 12a and 12b; alignment mechanisms (first and second interference cancellation units) 14a and 14b which adjust the relative positional relationship between the mirrors 12a and 12b and which are capable of three-dimensional position adjustment of the mirrors 12a and 12b, and a cell 16 to be filled with an analyte gas. While such two alignment mechanisms are here disposed, one of such alignment mechanism may be disposed as long as the relative positional relationship between the mirrors 12a and 12b can be adjusted.

Although not illustrated, the side of the body is preferably provided with a gas inlet through which the carbon dioxide isotope is injected and a port for adjusting the pressure in the body. In addition, the pair of mirrors 12a and 12b preferably have a reflectance of 99% or more, more preferably 99.99% or more.

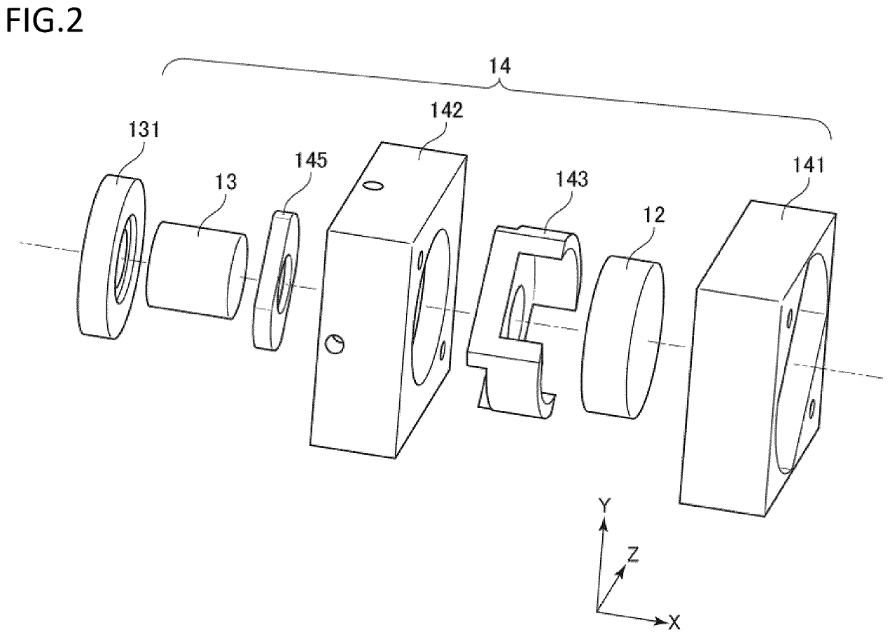

As illustrated in FIG. 2, an alignment mechanism 14 includes alignment bodies 141 and 142, a mirror mount 143 which is disposed in each hole provided in the alignment bodies 141 and 142 and on which a mirror 12 is to be mounted, and a sliding base 145. The sliding base 145, the piezoelectric element 13, and a piezoelectric element adapter 131 may be integrally formed with an adhesive or the like, without any limitation.

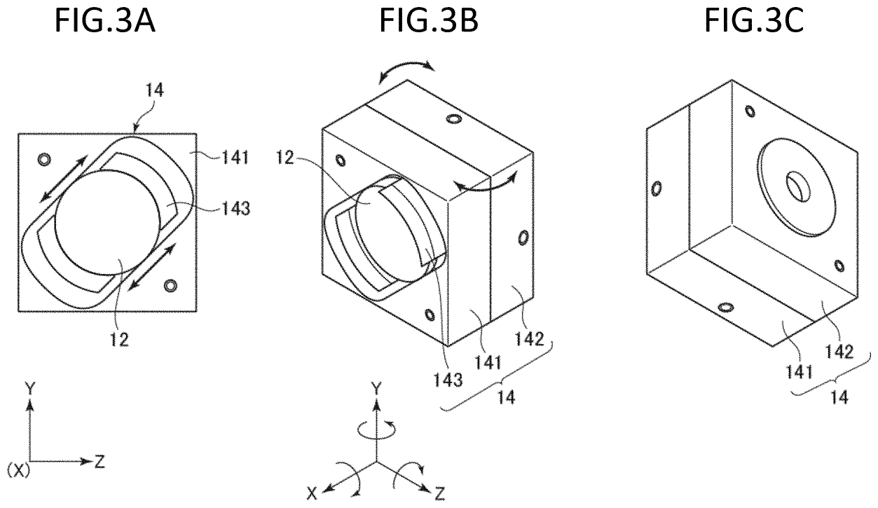

As illustrated in FIG. 3A, an alignment mechanism 14 is operated to thereby move a mirror 12 in a direction indicated by an arrow. Mount bodies 141 and 142 are not only movable in respective directions of the X-axis, the Y-axis, and the Z-axis, but also rotatable in about 360 degrees around respective axes of the X-axis, the Y-axis, and the Z-axis. Thus, the mount bodies 141 and 142 can be moved as indicated by an arrow illustrated in FIG. 3B. FIG. 3C is viewed from an alignment body 142 (rear surface).

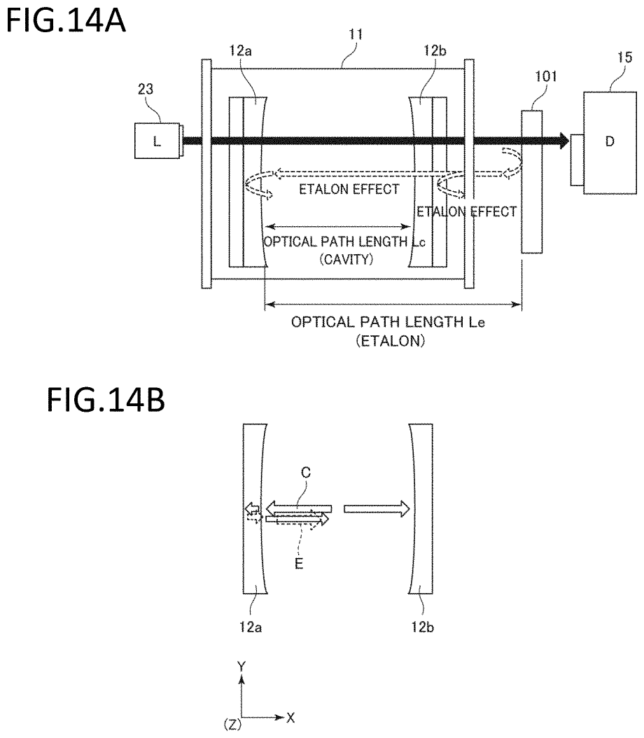

As illustrated in FIG. 14A, in the case where a conventional optical resonator 111 is used, the optical path of light reflected on rear surfaces of mirrors 12a and 12b, which are not highly-reflective surfaces, may be matched to the original optical axis of the optical resonator. FIG. 14B illustrates the state where the optical axis of light reflected on the highly-reflective surface of the mirror 12a and an optical axis E of light reflected on the rear surface thereof are matched to the original optical axis C of the optical resonator. In such a case, the light reflected on the rear surface reaches another optical component 101 or the like on such an optical axis, and further reflection occurs between such surfaces. This leads to not only diffused reflection of light of an optical path length Lc between the mirrors 12a and 12b, but also resonance at an optical path length Le between the mirror 12a and the optical component 101, the occurrence of the etalon effect, and the occurrence of a high noise on a baseline. The same phenomena also occur with respect to the mirror 12b, and light reflected on the rear surface of the mirror 12b reaches another optical component 101 or the like on such an optical axis, and further reflection occurs between such surfaces. This leads to not only diffused reflection of light of an optical path length Lc between the mirrors 12a and 12b, but also resonance at an optical path length between the mirror 12b and the optical component 101, the occurrence of the etalon effect, and the occurrence of a high noise on a baseline.

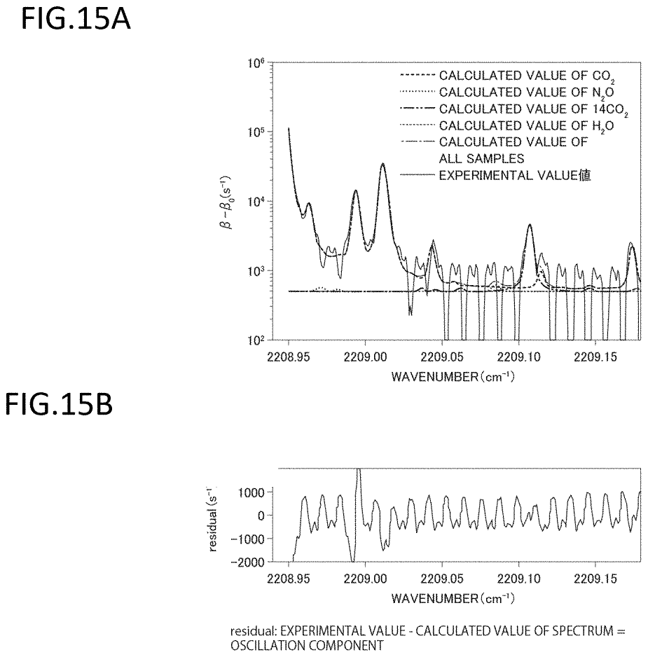

As illustrated in FIG. 15A, a measured spectrum of a gas containing ¹⁴CO₂ with which a cell is filled includes absorption of any component other than components contained in the gas. FIG. 15B illustrates an oscillation (periodical variation in apparent decay rate) extracted by determining the residual from the experimental value obtained in measurement and the absorption by CO₂, N₂O, ¹⁴CO₂, and H₂O contained in the gas, determined in calculation. Such an oscillation component may have a magnitude comparable with or more than absorption of ¹⁴CO₂ in analysis of a more trace of ¹⁴C, thereby causing a high noise.

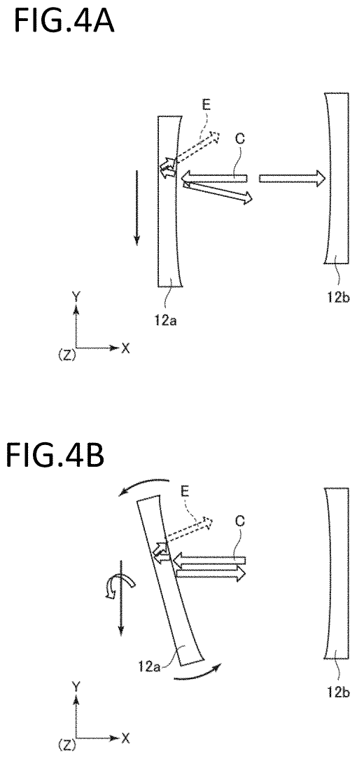

The present inventors have made studies based on the above findings, and as a result, an optical axis E of light generated by the etalon effect is displaced from an optical axis C by operating the alignment mechanism to move the position of the mirror 12a along with the Y-axis as illustrated in FIG. 4A, or rotating the mirror around the Z-axis as the center as illustrated in FIG. 4B. Thus, an optical resonator that can be suppressed in the etalon effect has been completed.

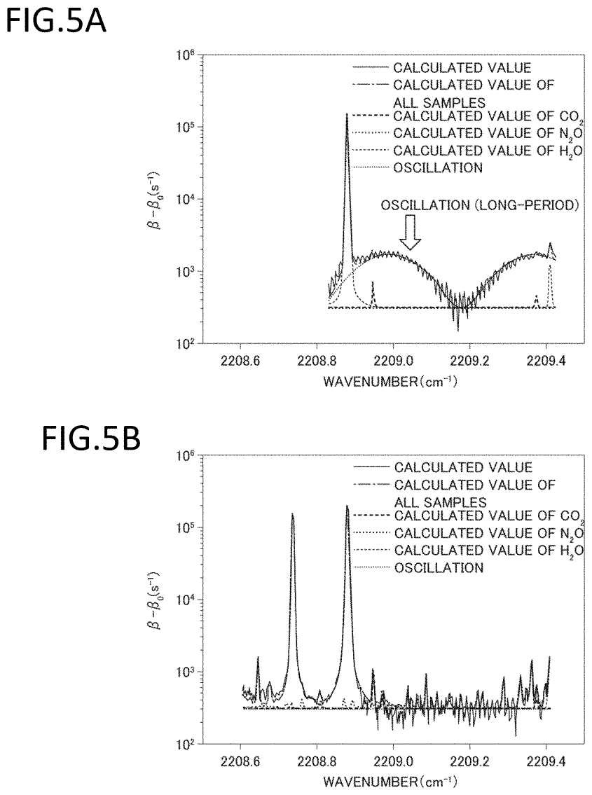

While any oscillation is observed in measurement with a conventional resonator as illustrated in FIG. 5A, any oscillation can be suppressed in measurement with the resonator of the present invention as illustrated in FIG. 5B, resulting in a significant decrease in noise.

A laser beam incident on and confined in the optical resonator 11 repeatedly reflects between the mirrors over several thousand to ten thousand times while the optical resonator 11 emits light at an intensity corresponding to the reflectance of the mirrors. Thus, the effective optical path length of the laser beam reaches several tens of kilometers, and a trace amount of analyte gas contained in the optical resonator can yield large absorption intensity.

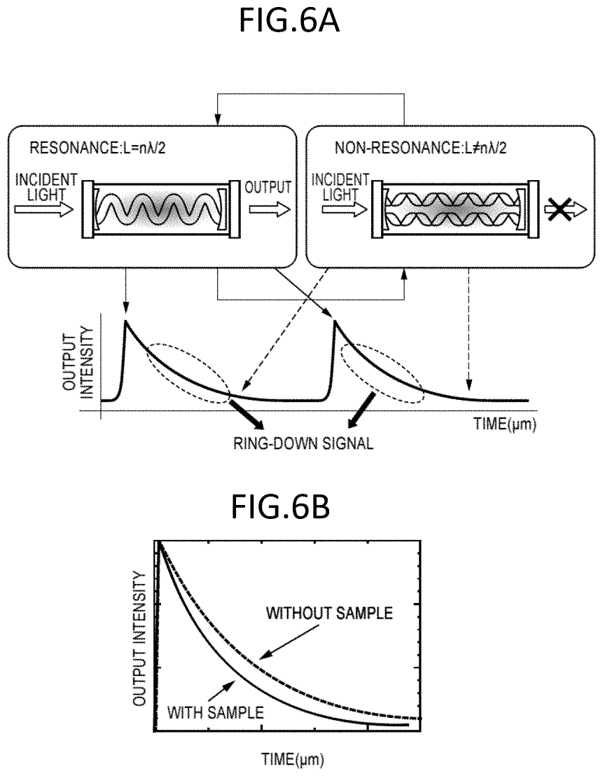

FIGS. 6A and 6B illustrate the principle of high-rate scanning cavity ring-down absorption spectroscopy (hereinafter may be referred to as “CRDS”) using laser beam.

As illustrated in FIG. 6A, the optical resonator in a resonance state between the mirrors outputs a high-intensity signal. In contrast, a non-resonance state between the mirrors, by the change through operation of the piezoelectric element 13, does not enable any signal to be detected due to the interference effect of light. In other words, an exponential decay signal (ring-down signal) as illustrated in FIG. 6A can be observed through a rapid change in the length of the optical resonator from a resonance state to a non-resonance state. Such a ring-down signal may be observed by rapid shielding of the incident laser beam with an optical switch.

In the case of the absence of a light-absorbing substance in the optical resonator, the dotted curve in FIG. 6B corresponds to a time-dependent ring-down signal output from the optical resonator. In contrast, the solid curve in FIG. 6B corresponds to the case of the presence of a light-absorbing substance in the optical resonator. In this case, the light decay time is shortened because of absorption of the laser beam by the light-absorbing substance during repeated reflection of the laser beam in the optical resonator. The light decay time depends on the concentration of the light-absorbing substance in the optical resonator and the wavelength of the incident laser beam. Thus, the absolute concentration of the light-absorbing substance can be calculated based on the Beer-Lambert law ii. The concentration of the light-absorbing substance in the optical resonator may be determined through measurement of a modulation in ring-down rate, which is proportional to the concentration of the light-absorbing substance.

The transmitted light leaked from the optical resonator is detected with the photodetector, and the concentration of ¹⁴CO₂ is calculated with the arithmetic device. The concentration of ¹⁴C is then calculated from the concentration of ¹⁴CO₂.

The distance between the mirrors 12a and 12b in the optical resonator 11, the curvature radius of the mirrors 12a and 12b, and the longitudinal length and width of the body should preferably be varied depending on the absorption wavelength of the carbon dioxide isotope (i.e., analyte). The length of the resonator is adjusted from 1 mm to 10 m, for example.

In the case of carbon dioxide isotope ¹⁴CO₂, an increase in length of the resonator contributes to enhancement of the effective optical path length, but leads to an increase in volume of the gas cell, resulting in an increase in amount of a sample required for the analysis. Thus, the length of the resonator is preferably 10 cm to 60 cm. Preferably, the curvature radius of the mirrors 12a and 12b is equal to or slightly larger than the length of the resonator.

The distance between the mirrors can be adjusted by, for example, several micrometers to several tens of micrometers through the drive of the piezoelectric element 13. The distance between the mirrors can be finely adjusted by the piezoelectric element 13 for preparation of an optimal resonance state.

The mirrors 12a and 12b (i.e., a pair of concave mirrors) may be replaced with combination of a concave mirror and a planar mirror or combination of two planar mirrors that can provide a sufficient optical path.

The mirrors 12a and 12b may be composed of sapphire glass, Ca, F₂, or ZnSe.

The cell 16 to be filled with the analyte gas preferably has a small volume because even a small amount of the analyte effectively provides optical resonance. The volume of the cell 16 may be 8 mL to 1,000 mL. The cell volume can be appropriately determined depending on the amount of a ¹⁴C source to be analyzed. For example, the cell volume is preferably 80 mL to 120 mL for a ¹⁴C source that is available in a large volume (e.g., urine), and is preferably 8 mL to 12 mL for a ¹⁴C source that is available only in a small volume (e.g., blood or tear fluid).

Evaluation of Stability Condition of Optical Resonator

The ¹⁴CO₂ absorption and the detection limit of CRDS were calculated based on spectroscopic data.

Spectroscopic data on ¹²CO₂ and ¹³CO₂ were retrieved from the high-resolution transmission molecular absorption database (HITRAN), and spectroscopic data on ¹⁴CO₂ were extracted from the reference “S. Dobos, et al., Z. Naturforsch, 44a, 633-639 (1989)”.

A Modification (Δβ) in ring-down rate (exponential decay rate) caused by ¹⁴CO₂ absorption (Δβ=β−β₀ where β is a decay rate in the presence of a sample, and β₀ is a decay rate in the absence of a sample) is represented by the following expression:

Δβ=σ₁₄(λ,T,P)N(T,P,X₁₄)c

where σ₁₄ represents the photoabsorption cross section of ¹⁴CO₂, N represents the number density of molecules, c represents the speed of light, and σ₁₄ and N are the function of λ (the wavelength of laser beam), T (temperature), P (pressure), and X₁₄=ratio ¹⁴C/^{Total}C.

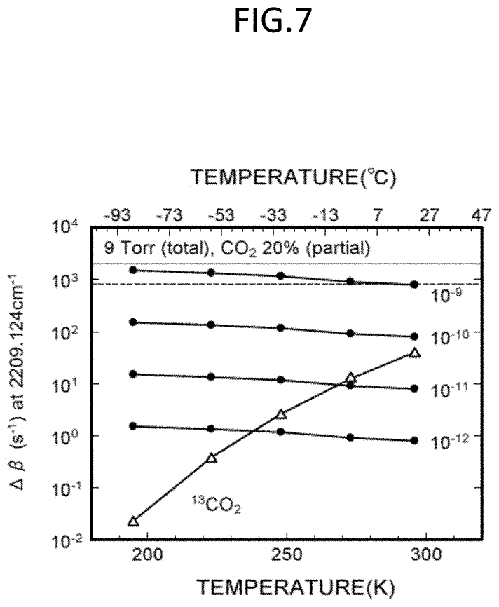

FIG. 7 illustrates the temperature dependence of calculated Δβ due to ¹³CO₂ absorption or ¹⁴CO₂ absorption. As illustrated in FIG. 7, ¹³CO₂ absorption is equal to or higher than ¹⁴CO₂ absorption at 300K (room temperature) at a ¹⁴C/^{Total}C of 10⁻¹⁰, 10⁻¹¹, or 10⁻¹², and thus the analysis requires cooling in such a case.

If a Modification (Δβ₀) in ring-down rate (corresponding to noise derived from the optical resonator) can be reduced to a level on the order of 10¹ s⁻¹, the analysis could be performed at a ratio ¹⁴C/^{Total}C on the order of 10⁻¹¹. Thus, cooling at about −40° C. is required during the analysis. In the case of a ratio ¹⁴C/^{Total}C of 10⁻¹¹ as a lower detection limit, the drawing suggests that requirements involve an increase (for example, 20%) in partial pressure of CO₂ gas due to concentration of the CO₂ gas and the temperature condition described above.

The cooler and the cooling temperature will be described in more detail in the section of a second aspect of the carbon isotope analysis device, described below.

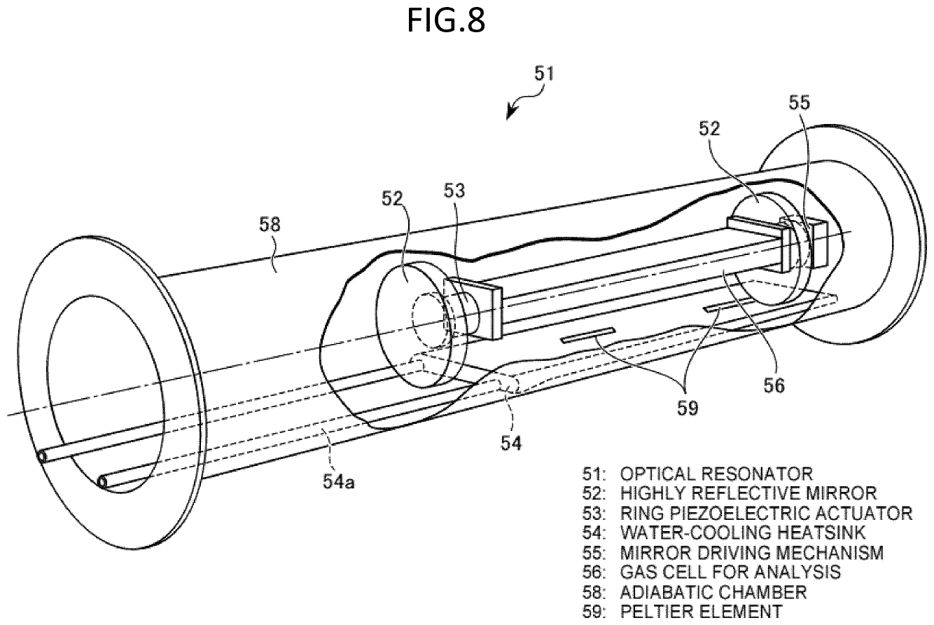

FIG. 8 illustrates a conceptual view (partially cross-sectional view) of a modification of the optical resonator 11 described. As illustrated in FIG. 8, an optical resonator 51 includes a cylindrical adiabatic chamber (vacuum device) 58, a gas cell 56 for analysis disposed in the adiabatic chamber 58, a pair of highly reflective mirrors 52 disposed at two ends of the gas cell 56, a mirror driving mechanism 55 disposed at one end of the gas cell 56, a ring piezoelectric actuator 53 disposed on the other end of the gas cell 56, a Peltier element 59 for cooling the gas cell 56, and a water-cooling heatsink 54 provided with a cooling pipe 54a connected to a circulation coiler (not illustrated).

### <Carbon Dioxide Isotope Generator>

The carbon dioxide isotope generator 40 includes a combustion unit that generates gas containing carbon dioxide isotope from carbon isotope, and a carbon dioxide isotope purifying unit. The carbon dioxide isotope generator 40 may be of any type that can convert carbon isotope to carbon dioxide isotope. The carbon dioxide isotope generator 40 should preferably have a function to oxidize a sample and to convert carbon contained in the sample to carbon dioxide.

The carbon dioxide isotope generator 40 may be a carbon dioxide generator (G) 41, for example, a total organic carbon (TOC) gas generator, a sample gas generator for gas chromatography, a sample gas generator for combustion ion chromatography, or an elemental analyzer (EA).

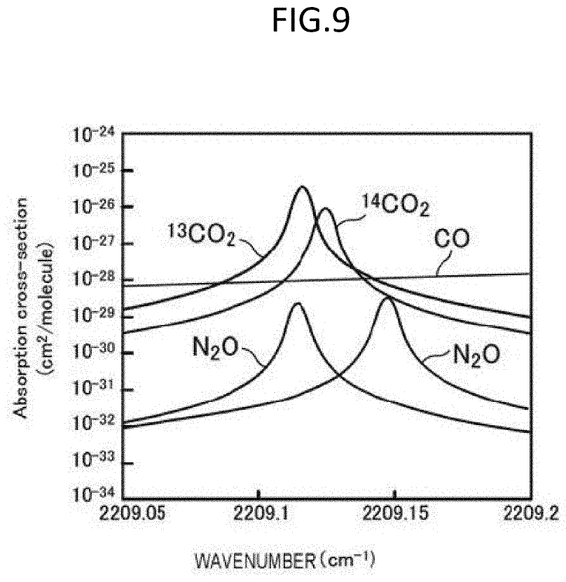

FIG. 9 is 4.5-μm wavelength range absorption spectra of ¹⁴CO₂ and competitive gases ¹³CO₂, CO, and N₂O under the condition of a CO₂ partial pressure of 20%, a CO partial pressure of 1.0×10⁻⁴% and a N₂O partial pressure of 3.0×10⁻⁸% at 273K.

Gas containing carbon dioxide isotope ¹⁴CO₂ (hereinafter merely “¹⁴CO₂”) can be generated through combustion of a pretreated biological sample; however, gaseous contaminants, such as CO and N₂O are generated together with ¹⁴CO₂ in this process. These CO and N₂O each exhibit a 4.5-μm wavelength range absorption spectrum as illustrated in FIG. 9 and interfere with the 4.5-μm wavelength range absorption spectrum assigned to ¹⁴CO₂. Thus, Co and N₂O should preferably be removed for improved analytical sensitivity.

A typical process of removing CO and N₂O involves collection and separation of ¹⁴CO₂ as described below. The process may be combined with a process of removing or reducing CO and N₂O with an oxidation catalyst or platinum catalyst.

(i) Collection and Separation of ¹⁴CO₂ by Thermal Desorption Column

The carbon dioxide isotope generator should preferably include a combustion unit and a carbon dioxide isotope purifying unit. The combustion unit should preferably include a combustion tube and a heater that enables the combustion tube to be heated. Preferably, the combustion tube is configured from refractory glass (such as quartz glass) so as to be able to accommodate a sample therein and is provided with a sample port formed on a part thereof. Besides the sample port, a carrier gas port through which carrier gas is introduced to the combustion tube may also be formed on the combustion tube. Herein, not only such an aspect where the sample port and the like are provided on a part of the combustion tube, but also a configuration where a sample introducing unit is formed as a separate component from the combustion tube at an end of the combustion tube and the sample port and the carrier gas port are formed on the sample introducing unit, may be adopted.

Examples of the heater include electric furnaces, specifically tubular electric furnaces that can place and heat a combustion tube therein. A typical example of the tubular electric furnace is ARF-30M (available from Asahi Rika Seisakusho).

The combustion tube should preferably be provided with an oxidation unit and/or a reduction unit packed with at least one catalyst, downstream of the carrier gas channel. The oxidation unit and/or the reduction unit may be provided at one end of the combustion tube or provided in the form of a separate component. Examples of the catalyst to be contained in the oxidation unit include copper oxide and a mixture of silver and cobalt oxide. The oxidation unit can be expected to oxidize H₂ and CO generated by combustion of a sample into H₂O and CO₂. Examples of the catalyst to be contained in the reduction unit include reduced copper and a platinum catalyst. The reduction unit can be expected to reduce nitrogen oxide (NOₓ) containing N₂O into N₂.

The carbon dioxide isotope purifying unit may be a thermal desorption column (CO₂ collecting column) of ¹⁴CO₂ in a gas generated by combustion of a biological sample, for use in gas chromatography (GC). Thus, any influence of CO and/or N₂O at the stage of detection of ¹⁴CO₂ can be reduced or removed. A CO₂ gas containing ¹⁴CO₂ is temporarily collected in a GC column and thus concentration of ¹⁴CO₂ is expected. Thus, it can be expected that the partial pressure of ¹⁴CO₂ increases.

(ii) Separation of ¹⁴CO₂ Through Trapping and Discharge of ¹⁴CO₂ with and from ¹⁴CO₂ Adsorbent

The carbon dioxide isotope generator 40b should preferably include a combustion unit and a carbon dioxide isotope purifying unit. The combustion unit may have a similar configuration to that described above.

The carbon dioxide isotope purifying unit may be made of any ¹⁴CO₂ adsorbent, for example, soda lime or calcium hydroxide. Thus, ¹⁴CO₂ can be isolated in the form of carbonate to thereby allow the problem of gaseous contaminants to be solved. ¹⁴CO₂ can be retained as carbonate and thus a sample can be temporarily reserved. Herein, phosphoric acid can be used in the discharge.

Such gaseous contaminants can be removed by any of or both (i) and (ii).

(iii) Concentration (Separation) of ¹⁴CO₂

¹⁴CO₂ generated by combustion of the biological sample is diffused in piping. Therefore, ¹⁴CO₂ may also be allowed to adsorb to an adsorbent and be concentrated, resulting in an enhancement in detection sensitivity (intensity). Such concentration can also be expected to separate ¹⁴CO₂ from CO and N₂O.

### <Light Generator>

The light generator 20 may be of any type that can generate light having the absorption wavelength of the carbon dioxide isotope. In this embodiment, a compact light generator will be described that can readily generate light of a 4.5-μm wavelength range, which is the absorption wavelength of radioactive carbon dioxide isotope ¹⁴CO₂.

The light generator 20 includes a single light source, a first optical fiber that transmits light from the light source, a second optical fiber that transmits light of a longer wavelength than the first optical fiber, the second optical fiber splitting from a splitting node of the first optical fiber and coupling with the first optical fiber at a coupling node downstream, a first amplifier that is disposed between the splitting node and the coupling node of the first optical fiber, a second amplifier that is disposed between the splitting node and the coupling node of the second optical fiber and that is different in band from the first amplifier, and a nonlinear optical crystal through which a plurality of light beams different in frequency are allowed to propagate through to thereby generate light at an absorption wavelength of the carbon dioxide isotope, due to the difference in frequency.

The light source 23 is preferably an ultrashort pulse generator. In the case of use of an ultrashort pulse generator as the light source 23, a high photon density per pulse enables a nonlinear optical effect to be easily exerted, simply generating light of a 4.5-μm wavelength range corresponding to an absorption wavelength of radioactive carbon dioxide isotope ¹⁴CO₂. A flux of comb-like light beams uniform in width of each wavelength (optical frequency comb, hereinafter may be referred to as “optical comb”.) is obtained, and thus the variation in oscillation wavelength can be negligibly small. In the case of a continuous oscillation generator as the light source, the variation in oscillation wavelength causes a need for measurement of the variation in oscillation wavelength with an optical comb or the like.

The light source 23 can be, for example, a solid-state laser, a semiconductor laser or a fiber laser that generates short pulse by mode-locking. In particular, a fiber laser is preferably used because a fiber laser is a practical light source that is compact and also excellent in stability to environment.

Such a fiber laser can be an erbium (Er)-based (1.55-μm wavelength range) or ytterbium (Yb)-based (1.04-μm wavelength range) fiber laser. An Er-based fiber laser is preferably used from the viewpoint of economics, and an Yb-based fiber laser is preferably used from the viewpoint of an enhancement in intensity of light.

A plurality of optical fibers 21 and 22 can be a first optical fiber 21 that transmits light from the light source and a second optical fiber 22 for wavelength conversion, the second optical fiber splitting from the first optical fiber 21 and coupling with the first optical fiber 21 downstream. The first optical fiber 21 can be any one connected from the light source to the optical resonator. A plurality of optical components and a plurality of optical fibers can be disposed on each path of the optical fibers.

It is preferred that the first optical fiber 21 can transmit high intensity of ultrashort light pulses without deterioration of the optical properties of the pulses. Specific examples can include a dispersion-compensating fiber (DCF) and a double-clad fiber. The first optical fiber 21 should preferably be composed of fused silica.

It is preferred that the second optical fiber 22 can efficiently generate ultrashort light pulses at a desired longer wavelength and transmit high intensity of ultrashort light pulses without deterioration of the optical properties of the pulses. Specific examples can include a polarization-maintaining fiber, a single-mode fiber, a photonic crystal fiber, and a photonic bandgap fiber. The optical fiber preferably has a length of several meters to several hundred meters depending on the amount of wavelength shift. The second optical fiber 22 should preferably be composed of fused silica.

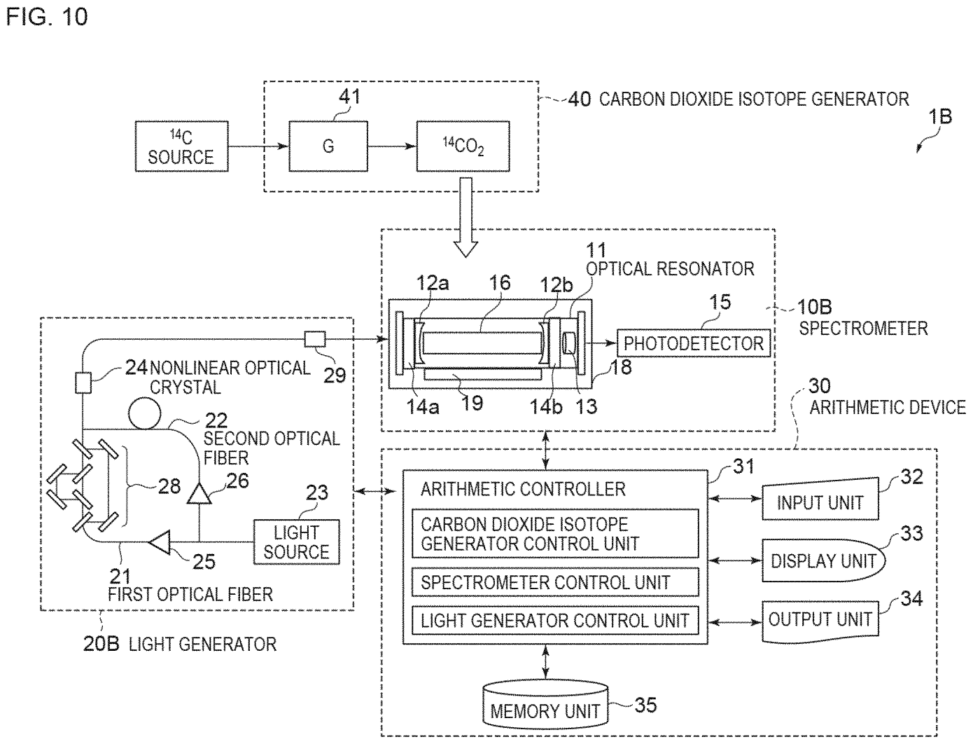

The light generator should preferably further include, for example, a delay line 28 including a wavelength filter that separates light from the light source 23 to a plurality of spectral components and a wavelength filter that adjusts the relative time delays of the plurality of spectral components and focuses on a nonlinear crystal 24, as illustrated in FIG. 10. The detail will be described later.

The amplifier, for example, a first amplifier 21 disposed on the route of the first optical fiber 21 is preferably an Er-doped optical fiber amplifier, and a second amplifier 26 disposed on the route of the second optical fiber 22 is preferably a Tm-doped optical fiber amplifier.

The first optical fiber 21 should preferably further include a third amplifier, more preferably a third amplifier between the first amplifier 21 and the coupling node, because the intensity of light obtained is enhanced. The third amplifier should preferably be an Er-doped optical fiber amplifier.

The first optical fiber 21 should preferably further include a wavelength-shifting fiber, more preferably a wavelength-shifting fiber between the first amplifier and the coupling node, because the intensity of light obtained is enhanced.

The nonlinear optical crystal 24 is appropriately selected depending on the incident light and the emitted light. In the present Example, for example, a PPMgSLT (periodically poled MgO-doped Stoichiometric Lithium Tantalate (LiTaO₃)) crystal, a PPLN (periodically poled Lithium Niobate) crystal, or a GaSe (Gallium selenide) crystal can be used from the viewpoint that light of a about 4.5-μm wavelength range is generated from each incident light. Since a single fiber laser light source is used, perturbation of optical frequency can be cancelled out in difference frequency generation as described below.

The length in the irradiation direction (longitudinal direction) of the nonlinear optical crystal 24 is preferably longer than 11 mm, more preferably 32 mm to 44 mm, because a high-power optical comb is obtained.

Difference frequency generation (hereinafter may be referred to as “DFG”) can be used to generate difference-frequency light. In detail, the light beams of different wavelengths (frequencies) from the first and second optical fibers 21 and 22 transmit through the non-linear optical crystal, to generate difference-frequency light based on the difference in frequency. In the present example, two light beams having wavelengths λ₁ and λ₂ are generated with the single light source 23 and propagate through the nonlinear optical crystal, to generate light in the absorption wavelength of carbon dioxide isotope based on the difference in frequency. The conversion efficiency of the DFG using the nonlinear optical crystal depends on the photon density of light source having a plurality of wavelengths (λ₁, λ₂, . . . λₓ). Thus, difference-frequency light can be generated from a single pulse laser light source through DFG.

The resultant 4.5-μm wavelength range light is an optical comb composed of a spectrum of frequencies (modes) with regular intervals (fᵣ) each corresponding to one pulse (frequency f=f_{ceo}+N·fᵣ, N: mode number). CRDS using the optical comb requires extraction of light having the absorption wavelength of the analyte into an optical resonator including the analyte. Herein, f_{ceo} is cancelled out and thus f_{ceo} is 0 in the optical comb generated, according to a process of difference frequency generation.

In the case of the carbon isotope analysis device disclosed in Non-Patent Document 1 by I. Galli, et al., laser beams having different wavelengths are generated from two laser devices (Nd:YAG laser and external-cavity diode laser (ECDL)), and light having the absorption wavelength of the carbon dioxide isotope is generated based on the difference in frequency between these laser beams. Both such beams correspond to continuous oscillation laser beams and thus are low in intensity of ECDL, and it is thus necessary for providing DFG sufficient in intensity to place a nonlinear optical crystal for use in DFG in an optical resonator and make both such beams incident thereinto, resulting in an enhancement in photon density. It is necessary for an enhancement in intensity of ECDL to excite a Ti:Sapphire crystal by a double wave of another Nd:YAG laser to thereby amplify ECDL light. Control of resonators for performing them is required, and an increase in device size is caused and operations are complicated. In contrast, a light generator according to an embodiment of the present invention is configured from a single fiber laser light source, an optical fiber having a length of several meters, and a nonlinear optical crystal, and thus has a compact size and is easy to carry and operate. Since a plurality of light beams are generated from a single light source, these beams exhibit the same width and timing of perturbation, and thus the perturbation of optical frequency can be readily cancelled through difference frequency generation without a perturbation controller.

In some embodiments, a laser beam may be transmitted through air between the optical resonator and the coupling node of the first optical fiber with the second optical fiber. Alternatively, the optical path between the optical resonator and the coupling node may optionally be provided with an optical transmission device including an optical system for convergence and/or divergence of a laser beam through a lens.

Since an optical comb may be obtained in the present analysis within the scope where the wavelength region for analysis of ¹⁴C is covered, the present inventors have focused on the following: higher-power light is obtained with a narrower oscillation spectrum of an optical comb light source. A narrower oscillation spectrum can allow for amplification with amplifiers different in band and use of a nonlinear optical crystal long in length. The present inventors have then made studies, and as a result, have conceived that high-power irradiation light having the absorption wavelength of carbon dioxide isotope is generated based on the difference in frequency, by (A) generating a plurality of light beams different in frequency, from a single light source, (B) amplifying intensities of the plurality of light beams obtained, by use of amplifiers different in band, respectively, and (C) allowing the plurality of light beams to propagate through a nonlinear optical crystal longer in length than a conventional nonlinear optical crystal, in generation of an optical comb by use of a difference frequency generation method. The present invention has been completed based on the above finding. There has not been reported any conventional difference frequency generation method that amplifies the intensity of light with a plurality of amplifiers different in band and provides high-power irradiation light obtained by use of a crystal long in length.

Absorption of light by a light-absorbing material, in the case of a high intensity of an absorption line and also a high intensity of irradiation light, is remarkably decreased in low level corresponding to the absorption of light and appears to be saturated with respect to the effective amount of light absorption (called saturation absorption). According to a SCAR theory (Saturated Absorption CRDS), in the case where light of a 4.5-μm wavelength range, high in intensity of an absorption line, is applied to a sample such as ¹⁴CO₂ in an optical resonator, a large saturation effect is initially exhibited due to a high intensity of light accumulated in an optical resonator and a small saturation effect is subsequently exhibited due to a gradual reduction in intensity of light accumulated in an optical resonator according to progression of decay, with respect to a decay signal (ring-down signal) obtained. Thus, a decay signal where such a saturation effect is exhibited is not according to simple exponential decay. According to such a theory, fitting of a decay signal obtained in SCAR enables the decay rate of a sample and the decay rate of the back ground to be independently evaluated, and thus not only the decay rate of a sample can be determined without any influence of the variation in decay rate of the back ground, for example, due to the parasitic etalon effect, but also absorption of light by ¹⁴CO₂ can be more selectively measured due to the saturation effect of ¹⁴CO₂ larger than that of a gaseous contaminant. Accordingly, use of irradiation light higher in intensity is more expected to result in an enhancement in sensitivity of analysis. The light generator of the present invention can generate irradiation light high in intensity, and thus is expected to result in an enhancement in sensitivity of analysis in the case of use for carbon isotope analysis.

While the optical comb is mainly described as the light source, the light source is not limited to the optical comb and any of various light sources can be used. For example, a light source may also be used in which perturbation of oscillation wavelength of light generated from a quantum cascade laser (hereinafter may be referred to as “QCL”) is corrected by a beat signal measurement device where narrow-line width light (optical comb) generated from the light generator is used as a frequency reference.

### <Arithmetic Device>

The arithmetic device 30 may be of any type that can determine the concentration of a light-absorbing substance in the optical resonator based on the decay time and ring-down rate and calculate the concentration of the carbon isotope from the concentration of the light-absorbing substance.

The arithmetic device 30 includes an arithmetic controller 31, such as an arithmetic unit used in a common computer system (e.g., CPU); an input unit 32, such as a keyboard or a pointing device (e.g., a mouse); a display unit 33, such as an image display (e.g., a liquid crystal display or a monitor); an output unit 34, such as a printer; and a memory unit 35, such as a ROM, a RAM, or a magnetic disk.

Although the carbon isotope analysis device according to the first aspect has been described above, the configuration of the carbon isotope analysis device should not be limited to the embodiment described above, and various modifications may be made. Other aspects of the carbon isotope analysis device will now be described by focusing on modified points from the first aspect.

[Second Aspect of Carbon Isotope Analysis Device]

<Cooler and Dehumidifier>

FIG. 10 is a conceptual view of a second aspect of the carbon isotope analysis device. As illustrated in FIG. 10, a spectrometer 1a may further include a Peltier element 19 that cools an optical resonator 11, and a vacuum device 18 that accommodates the optical resonator 11. Since the light absorption of ¹⁴CO₂ has temperature dependence, a decrease in temperature in the optical resonator 11 with the Peltier element 19 facilitates distinction between ¹⁴CO₂ absorption lines and ¹³CO₂ and ¹²CO₂ absorption lines and enhances the ¹⁴CO₂ absorption intensity. The optical resonator 11 is disposed in the vacuum device 18, and thus the optical resonator 11 is not exposed to external air, leading to a reduction in effect of the external temperature on the resonator 11 and an improvement in analytical accuracy.

The cooler for cooling the optical resonator 11 may be, for example, a liquid nitrogen vessel or a dry ice vessel besides the Peltier element 19. The Peltier element 19 is preferably used in view of a reduction in size of a spectrometer 10, whereas a liquid nitrogen vessel or a dry ice vessel is preferably used in view of a reduction in production cost of the device.

The vacuum device 18 may be of any type that can accommodate the optical resonator 11, apply irradiation light from the light generator 20 to the optical resonator 11, and transmit light transmitted, to the photodetector.

A dehumidifier may be provided. Dehumidification may be here carried out with a cooling means, such as a Peltier element, or by a membrane separation method using a polymer membrane, such as a fluorinated ion-exchange membrane, for removing moisture.

In the case that the carbon isotope analysis device 1 is used in a microdose test, the prospective detection sensitivity to the radioactive carbon isotope ¹⁴C is approximately 0.1 dpm/ml. Such a detection sensitivity “0.1 dpm/ml” requires not only use of “narrow-spectrum laser” as a light source, but also the stability of wavelength or frequency of the light source. In other words, the requirements include no deviation from the wavelength of the absorption line and a narrow line width. In this regard, the carbon isotope analysis device 1, which involves CRDS with a stable light source using “optical frequency comb light”, can solve such a problem. The carbon isotope analysis device 1 has an advantage in that the device can determine a low concentration of radioactive carbon isotope in the analyte.

The earlier literature (Hiromoto Kazuo et al., “Designing of ¹⁴C continuous monitoring based on cavity ring down spectroscopy”, preprints of Annual Meeting, the Atomic Energy Society of Japan, Mar. 19, 2010, p. 432) discloses determination of the concentration of ¹⁴C in carbon dioxide by CRDS in relation to monitoring of the concentration of spent fuel in atomic power generation. Although the signal processing using the fast Fourier transformation (FFT) disclosed in the literature has a high processing rate, the fluctuation of the baseline increases, and thus a detection sensitivity of 0.1 dpm/ml cannot be readily achieved.

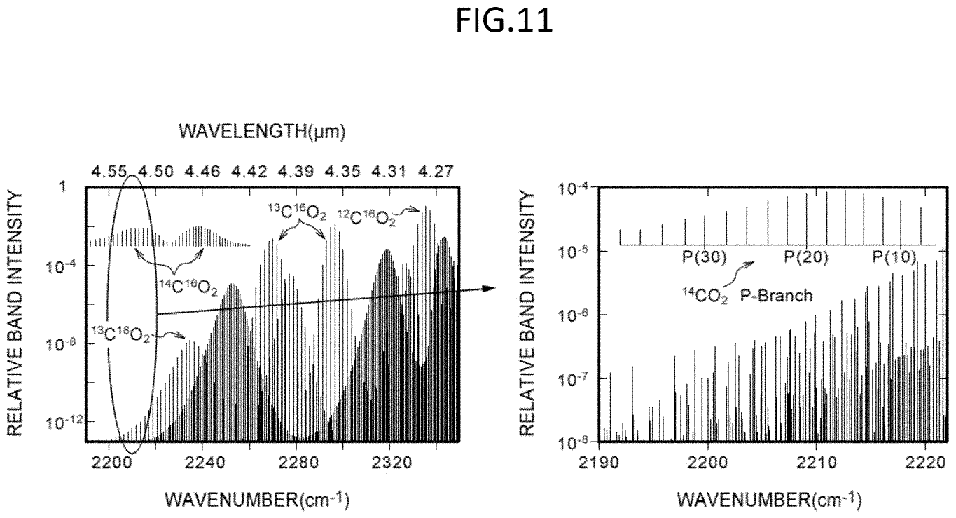

FIG. 11 (cited from Applied Physics Vol. 24, pp. 381-386, 1981) illustrates the relationship between the absorption wavelength and absorption intensity of analytical samples ¹²C¹⁶O₂, ¹³C¹⁸O₂, ¹³C¹⁶O₂, and ¹⁴C¹⁶O₂. As illustrated in FIG. 11, each carbon dioxide isotope has distinct absorption lines. Actual absorption lines have a finite width caused by the pressure and temperature of a sample. Thus, the pressure and temperature of a sample are preferably adjusted to atmospheric pressure or less and 273K (0° C.) or less, respectively.

Since the absorption intensity of ¹⁴CO₂ has temperature dependence as described above, the temperature in the optical resonator 11 is preferably adjusted to a minimum possible level. In detail, the temperature in the optical resonator 11 is preferably adjusted to 273K (0° C.) or less. The temperature may have any lower limit. In view of cooling effect and cost, the temperature in the optical resonator 11 is adjusted to preferably 173K to 253K (−100° C. to −20° C.), more preferably about 233K (−40° C.)

The spectrometer may further be provided with a vibration damper. The vibration damper can prevent a perturbation in distance between the mirrors due to the external vibration, resulting in an improvement in analytical accuracy. The vibration damper may be an impact absorber (polymer gel) or a seismic isolator. The seismic isolator may be of any type that can provide the spectrometer with vibration having a phase opposite to that of the external vibration.

### <Delay Line>

As illustrated in FIG. 10, a delay line 28 (optical path difference adjuster) may be provided on the first optical fiber 21. Thus, fine adjustment of the wavelength of light generated on the first optical fiber 21 is facilitated, and the maintenance of the light generator is facilitated.

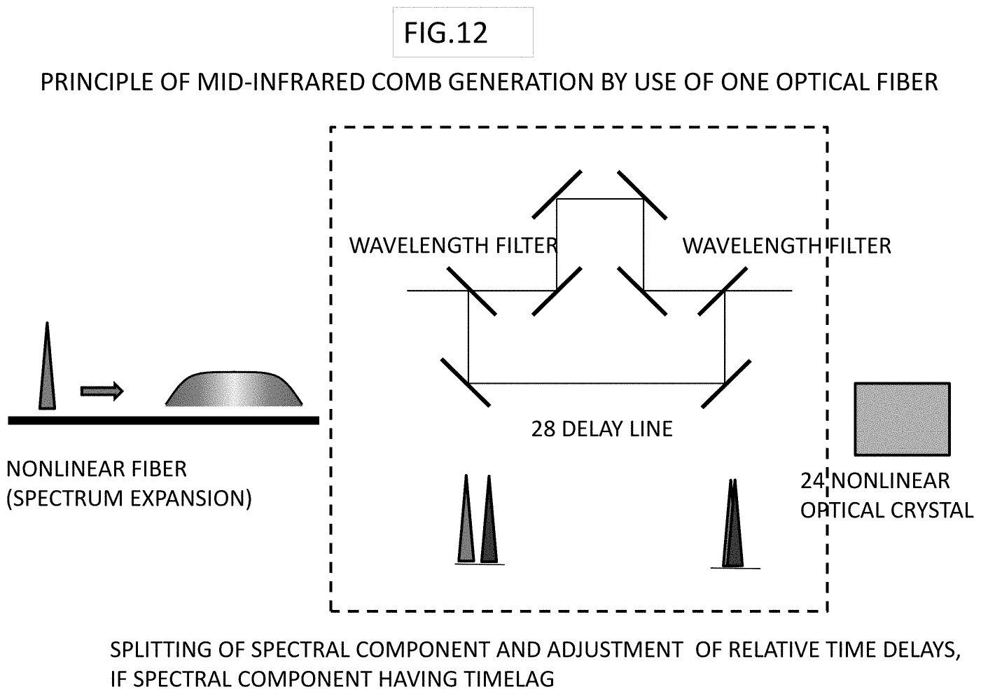

FIG. 12 illustrates the principle of mid-infrared comb generation by use of one optical fiber. A delay line 28 is described with reference to FIG. 10 and FIG. 12. The carbon isotope analysis device 1 in FIG. 10 includes a delay line 28 including a plurality of wavelength filters between the light source 23 and the nonlinear optical crystal 24. The first optical fiber 21 transmits the light from the light source 23, and the spectrum is expanded (spectrum expansion). If the spectral components have a time lag, the delay line 28 (optical path difference adjuster) splits the spectral components and adjusts the relative time delays, as illustrated in FIG. 10. The spectral components can be focused on a nonlinear crystal 25 to thereby generate a mid-infrared comb.

While such a delay line is exemplified as the wavelength filter, a dispersion medium may also be used without any limitation thereto.

### [Third Aspect of Carbon Isotope Analysis Device]

The present inventors have made further studies in order to achieve a further enhancement in analytical accuracy of a carbon isotope analysis device, and thus have found that an error in decay rate (residue in fitting due to a decay function for determining the decay rate of a ring-down signal) is caused due to optical switch performance (ON/OFF ratio) lower than expected performance. However, there has not been found any simple and effective ON/OFF control mechanism or method. Thus a demand has arisen for elimination of any residue in fitting of a ring-down signal and an enhancement in analytical accuracy, through an enhancement in optical switch performance (ON/OFF ratio).

The optical switch for use in the carbon isotope analysis device is any of various optical switches without particular limitation, and an acousto-optical modulator (hereinafter may be referred to as “AOM”.) can be used which includes an optical crystal and a piezo element. The piezo element of the AOM can be operated to allow acoustic wave to propagate in an optical crystal, allowing a periodical refractive index distribution to occur in the optical crystal and allowing incident light to be diffracted, and thus ON/OFF of light from a light source can be controlled. However, even when light emission is controlled OFF, a problem is that light which is slightly leaked out and not controlled causes an error in ring-down signal to occur. The present inventors have then completed a light generator including a mirror disposed and including a double-path.

That is, the present invention also relates to a carbon isotope analysis device including a light generator including a light source, an optical switch that controls ON/OFF of light from the light source, and a mirror that reflects light from the optical switch and sends the light back to the optical switch; a carbon dioxide isotope generator provided with a combustion unit that generates gas containing carbon dioxide isotope from carbon isotope, and a carbon dioxide isotope purifying unit; and a spectrometer including an optical resonator and a photodetector. The optical switch here used can be an acousto-optical modulator. A third aspect of the carbon isotope analysis device provides a light generator less in residue in fitting of a ring-down signal, and a radioactive carbon isotope analysis device and a radioactive carbon isotope analysis method, by use of the light generator.

### [First Aspect of Carbon Isotope Analysis Method]

The analysis of radioisotope ¹⁴C as an example of the analyte will now be described.

### (Pretreatment of Biological Sample)

(A) Carbon isotope analysis device 1 illustrated in FIG. 1 is provided. Biological samples, such as blood, plasma, urine, feces, and bile, containing ¹⁴C are also prepared as radioisotope ¹⁴C sources.

(B) The biological sample is pretreated to remove protein and thus to remove the biological carbon source. The pretreatment of the biological sample is categorized into a step of removing carbon sources derived from biological objects and a step of removing or separating the gaseous contaminant in a broad sense. In this embodiment, the step of removing carbon sources derived from biological objects will now be mainly described.

A microdose test analyzes a biological sample, for example, blood, plasma, urine, feces, or bile containing an ultratrace amount of ¹⁴C labeled compound. Thus, the biological sample should preferably be pretreated to facilitate the analysis. Since the ratio ¹⁴C/^{Total}C of ¹⁴C to total carbon in the biological sample is one of the parameters determining the detection sensitivity in the measurement due to characteristics of the CRDS unit, it is preferred to remove the carbon source derived from the biological objects contained in the biological sample.

Examples of deproteinization include insolubilization of protein with acid or organic solvent; ultrafiltration and dialysis based on a difference in molecular size; and solid-phase extraction. As described below, deproteinization with organic solvent is preferred, which can extract the ¹⁴C labeled compound and in which the organic solvent can be readily removed after treatment.

The deproteinization with organic solvent involves addition of the organic solvent to a biological sample to insolubilize protein. The ¹⁴C labeled compound adsorbed on the protein is extracted to the organic solvent in this process. To enhance the recovery rate of the ¹⁴C labeled compound, the solution is transferred to another vessel and fresh organic solvent is added to the residue to further extract the labeled compound. The extraction operations may be repeated several times. In the case that the biological sample is feces or an organ such as lung, which cannot be homogeneously dispersed in organic solvent, the biological sample should preferably be homogenized. The insolubilized protein may be removed by centrifugal filtration or filter filtration, if necessary.

The organic solvent is then removed by evaporation to yield a dry ¹⁴C labeled compound. The carbon source derived from the organic solvent can thereby be removed. Preferred examples of the organic solvent include methanol (MeOH), ethanol (EtOH), and acetonitrile (ACN). Particularly preferred is acetonitrile.

(C) The pretreated biological sample was combusted to generate gas containing carbon dioxide isotope ¹⁴CO₂ from the radioactive isotope ¹⁴C source. N₂O and CO are then removed from the resulting gas.

(D) Moisture is preferably removed from the resultant ¹⁴CO₂. For example, moisture is preferably removed from the ¹⁴CO₂ gas in the carbon dioxide isotope generator 40 by allowing the ¹⁴CO₂ gas to pass through a desiccant (e.g., calcium carbonate) or cooling the ¹⁴CO₂ gas for moisture condensation. Formation of ice or frost on the optical resonator 11, which is caused by moisture contained in the ¹⁴CO₂ gas, may lead to a reduction in reflectance of the mirrors, resulting in low detection sensitivity. Thus, removal of moisture improves analytical accuracy. The ¹⁴CO₂ gas is preferably cooled and then introduced into the spectrometer 10 for the subsequent spectroscopic process. Introduction of the ¹⁴CO₂ gas at room temperature significantly varies the temperature of the optical resonator, resulting in a reduction in analytical accuracy.

(E) The ¹⁴CO₂ gas is fed into the optical resonator 11 having the pair of mirrors 12a and 12b as illustrated in FIG. 1. The ¹⁴CO₂ gas is preferably cooled to 273K (0° C.) or less to enhance the absorption intensity of excitation light. The optical resonator 11 is preferably maintained under vacuum because a reduced effect of the external temperature on the optical resonator improves analytical accuracy.

(F) The alignment mechanism 14 of FIG. 2 is operated for adjustment so that the optical axis E of light reflected from the rear surfaces of the mirror 12a and the mirror 12b is not matched to the optical axis (optical axis of light reflected from the highly-reflective surfaces of the mirror 12a and the mirror 12b) C of the optical resonator, as illustrated in FIGS. 4A and 4B.

(G) First light obtained from the light source 23 is transmitted through the first optical fiber 21. The first light is transmitted through the second optical fiber 22 that splits from the first optical fiber 21 and couples with the first optical fiber 21 at a coupling node downstream, thereby allowing second light of a longer wavelength than the first light to be generated from the second optical fiber 22. The intensities of the resulting first light and second light are amplified by amplifiers 21 and 26 different in band, respectively. The first optical fiber 21 of a shorter wavelength generates light of a wavelength range of 1.3 μm to 1.7 μm, and the second optical fiber 22 of a longer wavelength generates light of a wavelength range of 1.8 μm to 2.4 μm. The second light then couples with the first optical fiber 21 downstream, the first light and the second light are allowed to propagate through the nonlinear optical crystal 24, and a mid-infrared optical frequency comb of a wavelength range from 4.5 μm to 4.8 μm, as light of a 4.5-μm wavelength range corresponding to the absorption wavelength of carbon dioxide isotope ¹⁴CO₂, is generated as irradiation light, based on the difference in frequency. A long-axis crystal having a length in the longitudinal direction of longer than 11 mm can be used as the nonlinear optical crystal 24, thereby generating high-intensity light.

(H) The carbon dioxide isotope ¹⁴CO₂ is in resonance with the light. To improve analytical accuracy, the external vibration of the optical resonator 11 is preferably reduced by a vibration absorber to prevent a perturbation in distance between the mirrors 12a and 12b. During resonance, the downstream end of the first optical fiber 21 should preferably abut on the mirror 12a to prevent the light from coming into contact with air. The intensity of light transmitted from the optical resonator 11 is then determined. As illustrated in FIG. 5, the light may be split and the intensity of each light obtained by such splitting may be measured.

(I) The concentration of carbon isotope ¹⁴C is calculated from the intensity of the transmitted light.

Although the carbon isotope analysis method according to the first aspect has been described above, the configuration of the carbon isotope analysis method should not be limited to the embodiment described above, and various modifications may be made. Other aspects of the carbon isotope analysis method will now be described by focusing on modified points from the first aspect.

[Second Aspect of Carbon Isotope Analysis Method]

The first aspect is made for solving the above problems from the viewpoint of improvement of the structure of the spectrometer. The present invention, however, can also solve the problems from the viewpoint of control.

(A) A spectrum is measured in the state of no gas (sample) in a cell. A spectrum of only periodical variation is obtained.

(B) A sample gas (for example, CO₂) is introduced and a spectrum is measured.

(C) The residual is determined from the respective spectra obtained in (A) and (B).

This enables a noise on a baseline to be significantly reduced.

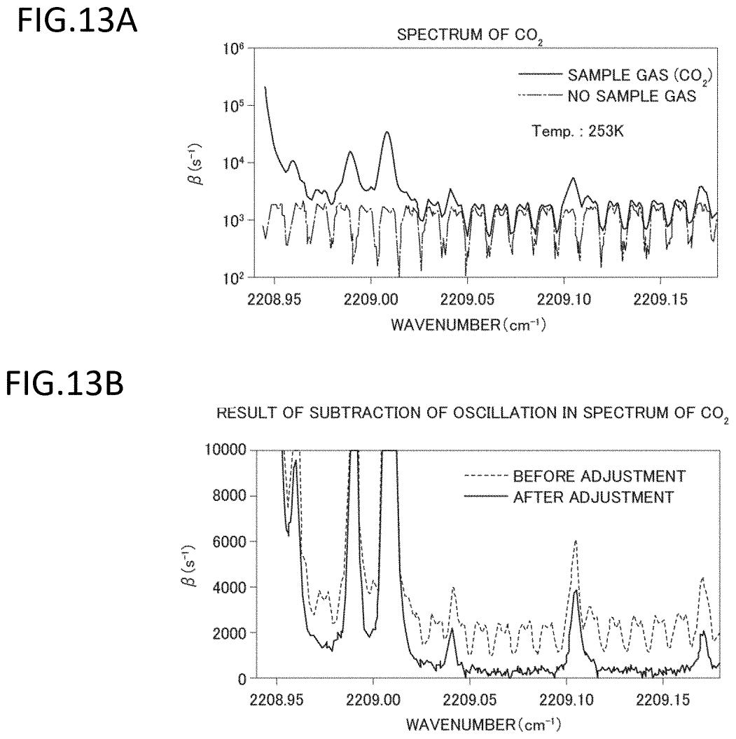

FIG. 13B is a spectrum obtained after the adjustment.

### Other Embodiments

Although the embodiment of the present invention has been described above, the descriptions and drawings as part of this disclosure should not be construed to limit the present invention. This disclosure will enable those skilled in the art to find various alternative embodiments, examples, and operational techniques.

The carbon isotope analysis device according to the embodiment has been described by focusing on the case where the analyte as a carbon isotope is radioisotope ¹⁴C. The carbon isotope analysis device can analyze stable isotopes ¹²C and ¹³C besides radioisotope ¹⁴C. In such a case, excitation light of 2 μm or 1.6 μm is preferably used in, for example, absorption line analysis of ¹²CO₂ or ¹³CO₂ based on analysis of ¹²C or ¹³C.

In the case of absorption line analysis of ¹²CO₂ or ¹³CO₂, the distance between the mirrors is preferably 10 to 60 cm, and the curvature radius of the mirrors is preferably equal to or longer than the distance therebetween.

Although the carbon isotopes ¹²C, ¹³C, and ¹⁴C exhibit the same chemical behaviors, the natural abundance of ¹⁴C (radioisotope) is lower than that of ¹²C or ¹³C (stable isotope). Artificial enrichment of the radioisotope ¹⁴C and accurate analysis of the isotope can be applied to observation of a variety of reaction mechanisms.

The carbon isotope analysis device according to the embodiment may further include a third optical fiber configured from a nonlinear fiber that splits from a first optical fiber and couples with the first optical fiber, downstream of a splitting node. Such first to third optical fibers can be combined to thereby generate two or more various light beams different in frequency.

An optical resonator including the alignment mechanism described in the first embodiment can allow for prevention of the etalon effect and thus cancelling of a noise on a baseline, and thus can be utilized in various applications. For example, a measurement device, medical diagnostic device, environmental measuring device (dating system), or the like partially including the configuration described in the first embodiment can also be produced.

An optical frequency comb corresponds to a light source where longitudinal modes of a laser spectrum are arranged at equal frequency intervals at a very high accuracy, and is expected to serve as a novel, highly functional light source in the fields of precision spectroscopy and high-accuracy distance measurement. Since many absorption spectrum bands of substances are present in the mid-infrared region, it is important to develop a mid-infrared optical frequency comb light source. The above light generator can be utilized in various applications.

As described above, the present invention certainly includes, for example, various embodiments not described herein. Thus, the technological range of the present invention is defined by only claimed elements of the present invention in accordance with the proper claims through the above descriptions.

### REFERENCE SIGNS LIST

1 carbon isotope analysis device
10A, 10B spectrometer
11 optical resonator
12a, 12b mirror
13 piezoelectric element
14a, 14b alignment mechanism (first or second
interference cancellation unit)
15 photodetector
16 cell
18 vacuum device
19 Peltier element
20A, 20B light generator
21 first optical fiber
22 second optical fiber
23 light source
24 nonlinear optical crystal
25 first amplifier
26 second amplifier
28 delay line
29 optical switch
30 arithmetic device
40 carbon dioxide isotope generator
50 light generator

1. A spectrometer comprising:
an optical resonator comprising a pair of mirrors;
a photodetector that determines intensity of light transmitted from the optical resonator; and
a first interference cancellation unit that adjusts a relative positional relationship between the mirrors.

2. The spectrometer according to claim 1, wherein the first interference cancellation unit is an alignment mechanism which prevents interference of light on an optical axis of irradiation light applied into the optical resonator, on which one of the mirrors is mountable, and which is capable of three-dimensional position adjustment of the mirrors.

3. The spectrometer according to claim 2, wherein the alignment mechanism satisfies at least one of:
(i) movability in respective directions of an X-axis, a Y-axis, and a Z-axis; and
(ii) rotatability in about 360 degrees around respective axes of the X-axis, the Y-axis, and the Z-axis;
in a case where the optical axis of irradiation light applied into the optical resonator is defined as the X-axis.

4. The spectrometer according to claim 1, wherein the spectrometer further comprises a second interference cancellation unit.

5. A carbon isotope analysis device comprising:
a carbon dioxide isotope generator provided with a combustion unit that generates gas containing carbon dioxide isotope from carbon isotope, and a carbon dioxide isotope purifying unit;
the spectrometer according to claim 1; and
a light generator.

6. The carbon isotope analysis device according to claim 5, wherein the light generator comprises a single light source, a first optical fiber that transmits first light from the light source, a second optical fiber that generates second light of a longer wavelength than the first light, the second optical fiber splitting from a splitting node of the first optical fiber and coupling with the first optical fiber at a coupling node downstream, a first amplifier that is disposed between the splitting node and the coupling node of the first optical fiber, a second amplifier that is disposed between the splitting node and the coupling node of the second optical fiber and that is different in band from the first amplifier, and a nonlinear optical crystal that allows a plurality of light beams different in frequency to propagate through to thereby generate a mid-infrared optical frequency comb of a wavelength range from 4.5 μm to 4.8 μm, from the difference in frequency, as light at an absorption wavelength of the carbon dioxide isotope.

7. The carbon isotope analysis device according to claim 5, wherein the light generator further comprises a delay line comprising a wavelength filter that separates the light from the light source to a plurality of spectral components, and a wavelength filter that adjusts the relative time delays of the plurality of spectral components and focuses the spectral components on the nonlinear crystal.

8. A carbon isotope analysis method, comprising:
generating carbon dioxide isotope from carbon isotope;
feeding the carbon dioxide isotope into an optical resonator having a pair of mirrors;
applying irradiation light having an absorption wavelength of the carbon dioxide isotope into the optical resonator;
adjusting a relative positional relationship between the mirrors so that an optical axis of the irradiation light and an optical axis of light generated by the etalon effect are not matched;
measuring the intensity of the transmitted light generated by resonance of carbon dioxide isotope excited by the irradiation light; and
calculating the concentration of the carbon isotope from the intensity of the transmitted light.

9. The carbon isotope analysis method according to claim 8, wherein the irradiation light is applied to radioactive carbon dioxide isotope ¹⁴CO₂.

10. The carbon isotope analysis method according to claim 8, further comprising:
measuring a first spectrum in the state where the optical resonator is not filled with gas;
measuring a second spectrum in the state where the optical resonator is filled with a sample gas; and
comparing the first and second spectra and removing an oscillation value.

11. The carbon isotope analysis method according to claim 8, comprising allowing a plurality of light beams to propagate through a nonlinear optical crystal to thereby generate a mid-infrared optical frequency comb of a wavelength range from 4.5 μm to 4.8 μm, as the irradiation light, due to the difference in frequency.
